(19) United States
(12) Patent Application Publication
(10) Pub. No.: US 2025/0182933 A1
(43) Pub. Date: Jun. 5, 2025

(54) ELECTRIC CABLE PROCESSING SYSTEM AND ELECTRIC CABLE MANUFACTURING METHOD

(71) Applicant: YAZAKI CORPORATION, Tokyo (JP)

(72) Inventors: Junya Rachi, Makinohara-shi, (JP); Yoshiki Shinohara, Makinohara-shi, (JP); Kosuke Okazaki, Makinohara-shi, (JP); Yuma Ogata, Makinohara-shi, (JP)

(21) Appl. No.: 19/047,592

(22) Filed: Feb. 6, 2025

Related U.S. Application Data
(63) Continuation of application No. PCT/JP2023/029197, filed on Aug. 9, 2023.

(30) Foreign Application Priority Data
Sep. 14, 2022 (JP) 2022-146415

(51) Int. Cl. H01B 13/00

(52) U.S. Cl. CPC H01B 13/0003

(57) ABSTRACT

An electric wire processing system includes a plurality of processing devices arranged in order of steps and a linear conveyor module configured to convey an electric wire to be processed. The linear conveyor module includes a first slider pair including two sliders configured to move back and forth in a first section and hold both ends of one electric wire, and a second slider pair including two sliders configured to move back and forth in a second section and hold the both ends of the one electric wire, and ranges of the first section and the second section are set based on a processing time in each section.

### CROSS-REFERENCE TO RELATED APPLICATIONS

This is a continuation of International Application No. PCT/JP2023/029197 filed on Aug. 9, 2023, and claims priority from Japanese Patent Application No. 2022-146415 filed on Sep. 14, 2022, the entire content of which is incorporated herein by reference.

### TECHNICAL FIELD

The present invention relates to an electric wire processing system including a plurality of processing devices arranged in order of steps of end processing of an electric wire, and a unit for conveying a workpiece (an end of the electric wire) along the plurality of processing devices, and relates to an electric wire manufacturing method.

### BACKGROUND ART

An electric wire processing system that automatically performs end processing of an electric wire used for a wire harness or the like of a vehicle generally includes a plurality of processing devices arranged in order of steps of end processing of the electric wire, and a unit for conveying a workpiece (an end of the electric wire) along the plurality of processing devices.

In the related art, in this type of electric wire processing system, as a unit for conveying an electric wire to be processed, a unit for pitch conveying the electric wire is used (see, for example, Patent Literature 1).

### CITATION LIST

### Patent Literature

Patent Literature 1: JP2001-357960A

### SUMMARY OF INVENTION

However, in the case of pitch conveyance of the electric wire, it is necessary to design and arrange the processing device in accordance with a conveyance pitch, and there is a problem in that equipment efficiency is deteriorated due to design restrictions.

The present invention has been made in view of the above circumstances, and an object of the present invention is to provide an electric wire processing system capable of increasing the degree of freedom of design and arrangement of a processing device and improving equipment efficiency.

In order to achieve the above object, an electric wire processing system and an electric wire manufacturing method according to the present invention are characterized as follows.

(1) An electric wire processing system including:
a plurality of processing devices arranged in a row in order of steps of end processing of an electric wire; and a linear conveyor module in which a plurality of sliders are configured to move on one guide rail disposed along the plurality of processing devices to convey an electric wire to be processed, in which
the linear conveyor module includes
a first slider pair including two sliders configured to reciprocate in a first section and hold both ends of one electric wire, and
a second slider pair including two sliders configured to reciprocate in a second section adjacently after the first section and hold the both ends of the one electric wire, and
ranges of the first section and the second section are set based on a processing time of the processing device in each section.

(2) An electric wire manufacturing method using an electric wire processing system,
the electric wire processing system including
a plurality of processing devices arranged in a row in order of steps of end processing of an electric wire, and a linear conveyor module in which a plurality of sliders are configured to move on one guide rail disposed along the plurality of processing devices to convey an electric wire to be processed,
the linear conveyor module including
a first slider pair including two sliders configured to reciprocate in a first section and hold both ends of one electric wire, and
a second slider pair including two sliders configured to reciprocate in a second section adjacently after the first section and hold the both ends of the one electric wire, and
ranges of the first section and the second section are set based on a processing time of the processing device in each section,
the method including:
holding the both ends of the electric wire by the first slider pair, and conveying the both ends to the processing device in the first section;
processing the both ends by the processing device in the first section;
holding the processed both ends of the electric wire by the second slider pair, and conveying the processed both ends to the processing device in the second section; and
processing the both ends by the processing device in the second section.

According to the present invention, since the linear conveyor module including the guide rail and the plurality of sliders is used as a unit for conveying ends of an electric wire to be processed, stop positions of the sliders holding the electric wire can be optionally set. Therefore, as compared with a case of pitch conveyance, the degree of freedom of design and arrangement of the processing device can be increased, and equipment efficiency can be improved.

The present invention has been briefly described above. Details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a perspective view illustrating a schematic configuration of an electric wire processing system according to an embodiment of the present invention;

FIG. 2 is a schematic plan view illustrating operations of the electric wire processing system according to the embodiment of the present invention;

FIG. 3 is a schematic plan view illustrating operations next to those illustrated in FIG. 2;

FIG. 4 is a schematic plan view illustrating operations next to those illustrated in FIG. 3;

FIG. 5 is a schematic plan view illustrating operations next to those illustrated in FIG. 4;

FIG. 6 is a schematic plan view illustrating operations next to those illustrated in FIG. 5; and

FIG. 7 is a schematic plan view illustrating operations next to those illustrated in FIG. 6.

### DESCRIPTION OF EMBODIMENTS

A specific embodiment of the present invention will be described below with reference to the drawings.

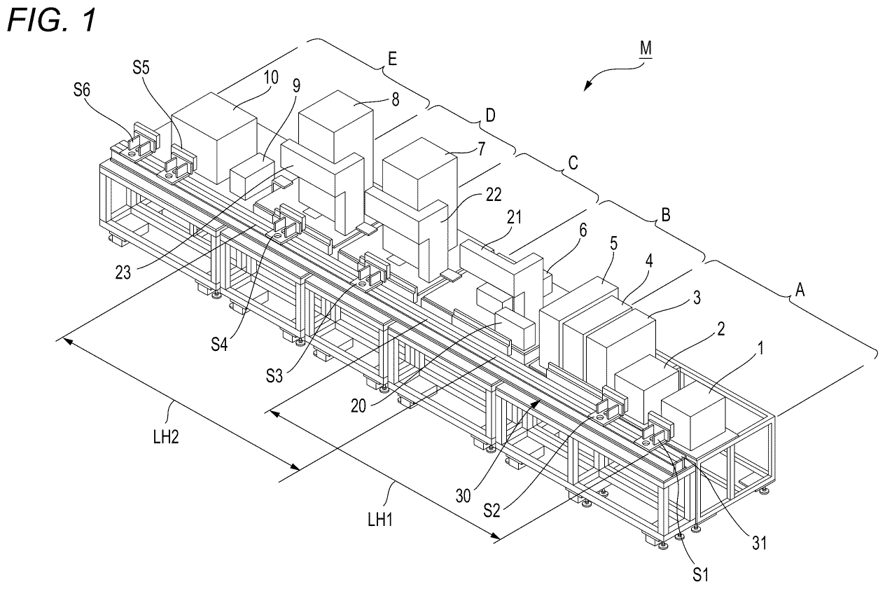

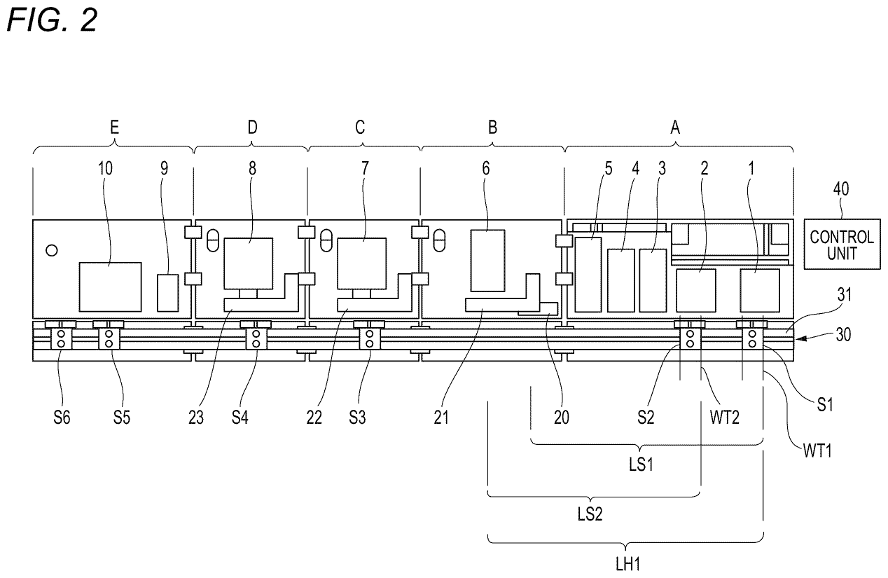

FIG. 1 is a perspective view illustrating a schematic configuration of an electric wire processing system according to an embodiment of the present invention, and FIGS. 2 to 7 each are a schematic plan view illustrating operations of the electric wire processing system.

As illustrated in FIGS. 1 to 7, an electric wire processing system M according to the present embodiment includes a plurality of processing devices 1 to 10 arranged in a row in order of steps A to E of end processing of an electric wire, and a linear conveyor module 30 that conveys ends (workpieces) of an electric wire to be processed. In the linear conveyor module 30, a plurality of sliders S1 to S6 move on one guide rail 31 disposed along the plurality of processing devices 1 to 10 to convey ends WT1 and WT2 of the electric wire to be processed to predetermined positions corresponding to the respective processing devices 1 to 10.

The linear conveyor module 30 according to the present embodiment is implemented by a linear motor including the single guide rail 31 and the six sliders S1 to S6 that move on the guide rail 31. Since the six sliders S1 to S6 move on the same single guide rail 31, the order of arrangement thereof cannot be changed, but the sliders S1 to S6 can be moved to and stopped at any desired position. Actually, a movable range of each of the sliders S1 to S6 is set in advance by a control program executed by a control unit 40 that controls each of the sliders S1 to S6 as described later. Each of the sliders S1 to S6 may return to original positions set for the respective sliders S1 to S6 every time an operation of one reciprocation is completed or every predetermined timing.

Each of the sliders S1 to S6 is equipped with an electric wire chuck (an electric wire clamp) (not illustrated) that holds the ends WT1 and WT2 of the electric wire. The sliders S1 to S6 are each provided with a necessary number of electric wire chucks in order to accommodate an electric wire including a plurality of core wires, such as a twisted wire including two core wires in one electric wire. In FIG. 2 and the like, an example is illustrated in which each of the sliders S1 to S6 is equipped with two electric wire chucks.

When processing both ends of one single electric wire, two sliders are paired and grip both ends of the one electric wire curved in a U-shape. In the present embodiment, the slider S1 and the slider S2 constitute a first pair (a first slider pair), the slider S3 and the slider S4 constitute a second pair (a second slider pair), the slider S5 and the slider S6 constitute a third pair (a third slider pair), and the sliders S1 to S6 are each controlled as pairs. In the system according to the present embodiment, since six sliders S1 to S6 are provided, six ends of three products can be processed simultaneously.

There are prepared five steps A to E for end processing of an electric wire in a larger classification. Some of the steps A to E include a plurality of steps in a smaller classification. Each of the steps A to E is provided with a stand (reference numbers are omitted since some are not illustrated), and the processing devices 1 to 10 for executing contents of each step are mounted on the stand. The processing devices 1 to 10 are provided to perform, for example, the following processes. Here, the contents of the processes themselves do not need to be specifically stated, and are represented in a simplified manner to be distinguishable.
processing device 1=electric wire set 1
processing device 2=electric wire set 2
processing device 3=trimming 1
processing device 4=trimming 2
processing device 5=peeling
processing device 6=ultrasonic single-wire conversion
processing device 7=crimping 1
processing device 8=crimping 2
processing device 9=end cutting
processing device 10=electric wire discharge

Although the term “processing device” is used as the name, some of them, such as the processing devices 1 and 2 (electric wire sets 1 and 2) and the processing device 10 (electric wire discharge), do not necessarily perform “processing” (simply “hand” the electric wire), but for convenience, all of them are referred to as “processing devices”. The processing devices 1 to 5 (electric wire set, trimming, and peeling) are arranged to perform the step A of the larger classification, and the processing device 6 (ultrasonic single-wire conversion) is arranged to perform the step B of the larger classification. The processing devices 7 and 8 (crimping) are 20 arranged to perform the steps C and D of the larger classification, and the processing devices 9 and 10 (end cutting, discharge) are arranged to perform the step E of the larger classification.

Steps B, C, and D, which are respectively provided with the processing device 6 (ultrasonic single-wire conversion), the processing device 7 (crimping 1), and the processing device 8 (crimping 2), are respectively provided with electric wire transfer devices 21, 22, and 23 for transferring the ends WT1 and WT2 of the electric wire to and from the sliders S1 to S6 during processing.

Further, since only one processing device 6 (ultrasonic single-wire conversion) is provided in the step B, a temporary placement chuck (an intermediate chuck) 20 is provided in the step B for temporarily placing, when processing one end of an electric wire, the other end of the electric wire. The temporary placement chuck 20 is usually retracted to a retracted position lower than an end of an electric wire being conveyed by the slider so as not to come into contact with the end of the electric wire. When the other electric wire to be temporarily placed is conveyed by the slider, the temporary placement chuck 20 is raised to grip the end of the electric wire.

The linear conveyor module 30 sequentially conveys the ends WT1 and WT2 of the electric wire to predetermined positions corresponding to the processing devices 1 to 10. Movement sections LS1 to LS6 of the sliders S1 to S6 are determined in advance. When taken as a pair, a movement section of the sliders S1 and S2 constituting the first slider pair (the first pair) is roughly set as a first section LH1. In addition, a movement section of the sliders S3 and S4 constituting the second slider pair (the second pair) is roughly set as a second section LH2. Further, a movement section of the sliders S5 and S6 constituting the third slider pair (the third pair) is roughly set as a third section LH3. As can be seen from FIGS. 2 to 7, each of the sections LH1, LH2, and LH3 is set across a plurality of steps (a plurality of processing devices) since the corresponding sliders sequentially convey the ends WT1 and WT2 of the electric wire to an adjacent step or a further adjacent step.

Ranges of the first section LH1, the second section LH2, and the third section LH3 are set based on processing times of the processing devices 1 to 10 in each section. For example, the ranges of the first to third sections LH1 to LH3 are determined such that working times of the first to third sections LH1 to LH3 are roughly uniform.

Next, operations will be described.

Here, a case will be described as an example in which both ends WT1 and WT2 of the electric wire curved in a U-shape are treated simultaneously. In the following description, “linear conveyance” indicates that the sliders S1 to S6 are linearly driven by a linear motor control executed by the control unit 40.

First, as illustrated in FIG. 2, the processing devices 1 and 2 (electric wire sets 1 and 2) set the ends WT1 and WT2 of the electric wire on the sliders S1 and S2 positioned at initial positions, respectively. That is, the ends WT1 and WT2 of the electric wire are respectively gripped by the electric wire chucks of the sliders S1 and S2.

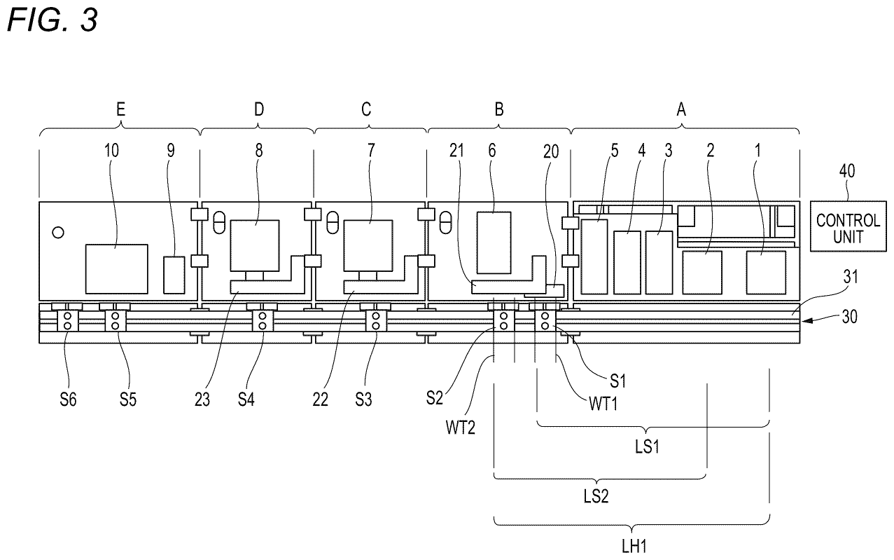

Next, the both gripped ends WT1 and WT2 of the electric wire are linearly conveyed to predetermined positions corresponding to the processing devices 3 and 4 (trimming 1 and 2), where the both ends WT1 and WT2 of the electric wire are trimmed by the processing devices 3 and 4, and then linearly conveyed to the processing device 5 (peeling) to perform peeling. Next, the both peeled ends WT1 and WT2 of the electric wire are linearly conveyed to the position of the step B as illustrated in FIG. 3, one end WT2 of the electric wire is deposited in the electric wire transfer device 21 for ultrasonic single-wire conversion by the processing device 6. The other end WT1 is deposited on the temporary placement chuck 20. Accordingly, both the sliders S1 and S2 constituting the first pair become free, and thus the sliders S1 and S2 can be moved to original positions and prepared for a next work.

The term “ultrasonic single-wire conversion” means that, when a conductor of a core wire includes a large number of thin metal wires, a single conductor is formed by ultrasonic bonding.

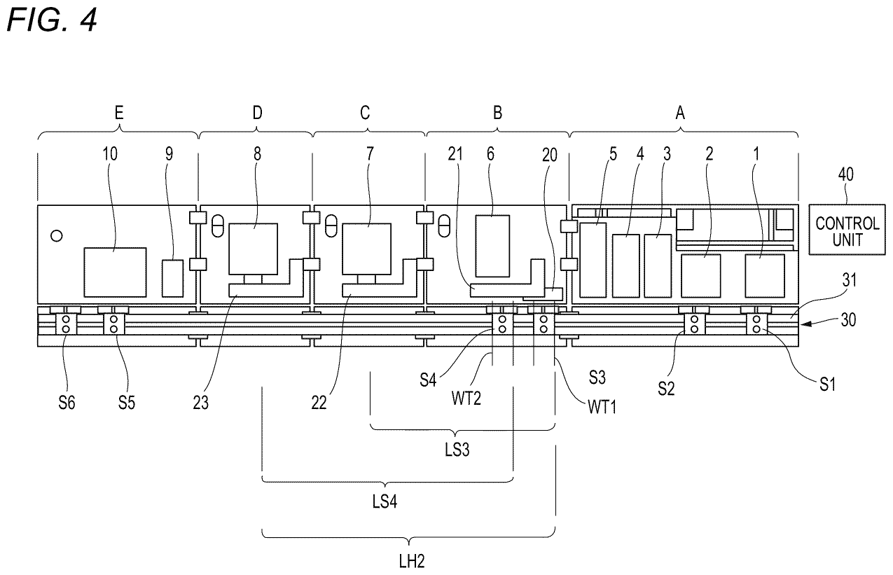

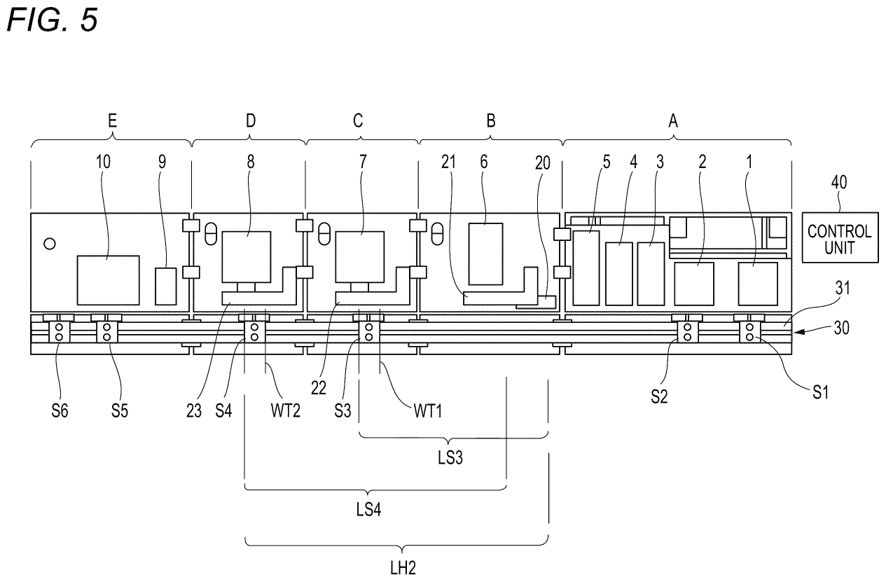

After completion of the ultrasonic single-wire conversion processing, as illustrated in FIG. 4, the slider 4 receives the one end WT2 of the electric wire from the electric wire transfer device 21, and the slider 3 receives the other end WT1 of the electric wire from the temporary placement chuck 20. Then, as illustrated in FIG. 5, the slider S3 and the slider S4 linearly convey the received ends WT1 and WT2 of the electric wire, respectively, and deposit the ends WT1 and WT2 in the electric wire transfer devices 22 and 23 in steps C and D in which the processing devices 7 and 8 (crimping 1 and 2) are provided. Then, end crimping is performed by the processing devices 7 and 8.

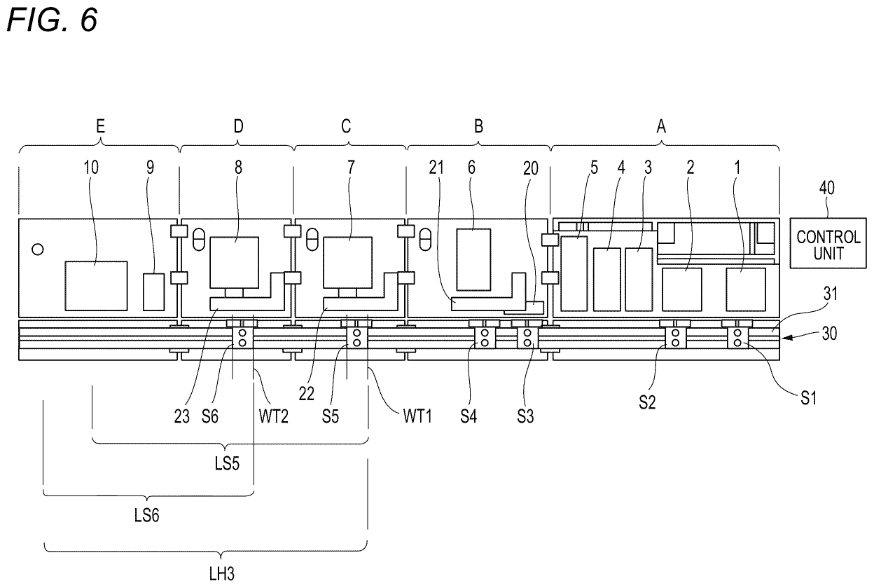

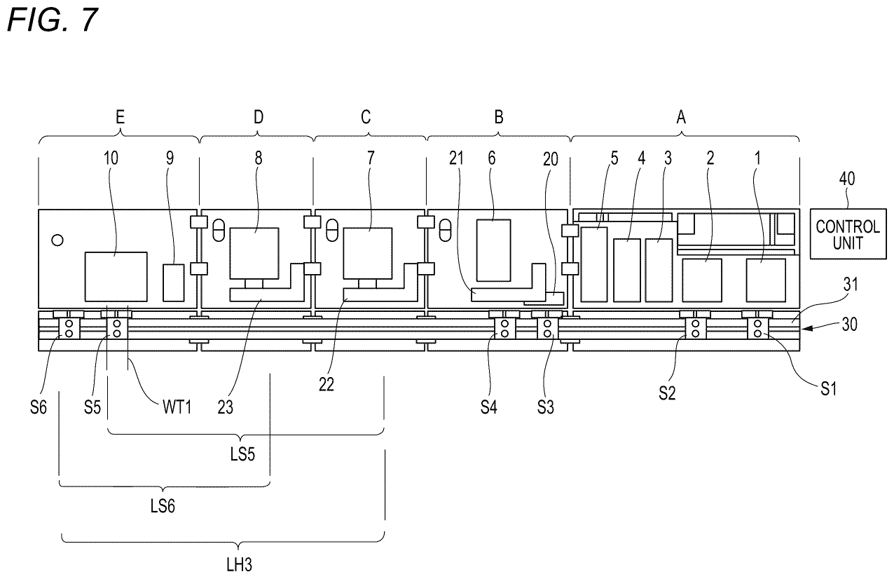

The ends WT1 and WT2 of the electric wire which have been subjected to the end crimping processing are received by the slider 5 and the slider 6 from the electric wire transfer devices 22 and 23 as illustrated in FIG. 6, and are linearly conveyed to the next step E as illustrated in FIG. 7. The slider 6 moved to the position of the step E moves to the retracted position after the end WT2 of the electric wire is discharged by the processing device 10 (electric wire discharge), and the slider 5 transfers the end WT2 of the electric wire to the processing device 10. When end cutting processing is necessary, the electric wire is subjected to end cutting processing by the processing device 9 (end cutting), and then transferred to the processing device 10 (electric wire discharge).

As described above, according to the electric wire processing system M of the present embodiment, since the linear conveyor module 30 including the guide rail 31 and the plurality of sliders S1 to S6 is used as a unit for conveying the ends WT1 and WT2 of the electric wire to be processed, the positions of the sliders S1 to S6 holding the electric wire can be optionally set. Therefore, the design of the steps becomes easier as compared with a case of pitch conveyance. That is, the arrangement of the processing devices 1 to 10 can be freely determined without considering a conveyance pitch, and movement positions of the sliders S1 to S6 of the linear conveyor module 30 can be determined according to the arrangement, which results in improved equipment efficiency.

Regarding the linear conveyor module 30, since the positions of the sliders S1 to S6 can be optionally set, fine adjustment of a movement position of the electric wire in accordance with the respective processing devices 1 to 10 can be easily performed. Since it is easy to extend the guide rail 31 of the linear conveyor module 30 and increase the number of sliders S1 to S6, it is also easy to cope with an addition of the processing device.

Since the ranges of the sections LH1 to LH3 in which the slider pairs reciprocate are set based on the processing time in each of the sections LH1 to LH3, for example, waiting times of the sliders S1 to S6 can be reduced by equalizing the working times of the sections LH1 to LH3 (that is, by setting the ranges of the sections LH1 to LH3 such that the working times are equalized). That is, when there is a difference in processing times between the first section LH1 and the second section LH2 or between the second section LH2 and the third section LH3, a waiting time may occur for the slider in the section having a shorter processing time, but by setting the ranges of the sections such that the difference in processing times does not become large, the waiting time for the slider can be reduced as much as possible. As a result, a takt time of the entire electric wire processing can be shortened.

Since the temporary placement chuck 20 is provided in the second section LH2 immediately after the first section LH1, both ends of the electric wire can be deposited in the second section LH2 immediately after the work in the first section LH1 is completed without providing a waiting time. Therefore, the first slider pair (the sliders S1 and S2) can be released without wasting time, and can be moved to the next work freely, and the takt time can be further shortened.

The present invention is not limited to the embodiment described above, and can be appropriately modified, improved, or the like. In addition, materials, shapes, sizes, numbers, arrangement positions, and the like of components in the embodiment described above are freely selected and are not limited as long as the present invention can be implemented.

For example, the case in which the sliders S1 to S6 reciprocate in the ranges of the predetermined reciprocating sections LH1 to LH3 has been described. Therefore, when a delay occurs in another section, the slider in the next section waits for conveyance of the electric wire from the previous section. Therefore, when a delay temporarily occurs in one of the sections, if the slider in the other sections can be moved to the section in which the delay occurs to recover from the delay, the takt time can be further shortened.

Here, the features of the electric wire processing system and the electric wire manufacturing method according to the embodiment of the present invention described above are briefly summarized and listed in the following [1] to [3]. [1] An electric wire processing system (M) including:
a plurality of processing devices (1 to 10) arranged in a row in order of steps (A to E) of end processing of an electric wire; and a linear conveyor module (30) in which a plurality of sliders (S1 to S6) are configured to move on one guide rail (31) disposed along the plurality of processing devices (1 to 10) to convey an electric wire to be processed, in which
the linear conveyor module (30) includes
   a first slider pair including two sliders (S1, S2) configured to reciprocate in a first section (LH1) and hold both ends (WT1, WT2) of one electric wire, and
   a second slider pair including two sliders (S3, S4) configured to reciprocate in a second section (LH2) adjacently after the first section (LH1) and hold the both ends (WT1, WT2) of the one electric wire, and
ranges of the first section (LH1) and the second section (LH2) are set based on a processing time of the processing device (1 to 8) in each section (LH1, LH2).

According to the configuration of the above [1], since the linear conveyor module (30) is used as a unit for conveying a workpiece (ends of an electric wire to be processed), the positions of the sliders (S1 to S6) holding the electric wire can be optionally set. Therefore, the design of the steps becomes easier as compared with a case of pitch conveyance. That is, the arrangement of the processing devices can be freely determined without considering a conveyance pitch, and movement positions of the sliders (S1 to S6) of the linear conveyor module (30) can be determined according to the arrangement. Regarding the linear conveyor module (30), since the positions of the sliders (S1 to S6) can be optionally set, the fine adjustment of the movement position of the electric wire in accordance with the respective processing devices (1 to 10) can be easily performed. Since it is easy to extend the guide rail (31) of the linear conveyor module (30) and increase the number of sliders (S1 to S6), it is also easy to cope with an addition of the processing device.

Since the ranges of the sections (LH1, LH2) in which the slider pairs reciprocate are set based on the processing time in each of the sections, for example, the waiting times of the sliders (S1 to S6) can be reduced by equalizing the working times of the sections (LH1, LH2) (that is, by setting the ranges of the sections such that the working times are equalized). That is, when there is a difference in processing times between the first section (LH1) and the second section (LH2), a waiting time may occur for the slider in the section having a shorter processing time, but by setting the ranges of the sections (LH1, LH2) such that the difference in processing times does not become large, the waiting time for the slider can be reduced as much as possible. As a result, the takt time of the entire electric wire processing can be shortened.

[2] The electric wire processing system (M) according to the above [1], further including
a temporary placement chuck (20) configured to temporarily place and hold, when the processing device (6) in the second section (LH2) processes only one end (WT2) of the electric wire, the other end (WT1) of the electric wire during processing of the one end (WT2) of the electric wire in the second section (LH2).

According to the configuration of the above [2], since the temporary placement chuck (20) is provided in the second section (LH2) immediately after the first section (LH1), both ends (WT1, WT2) of the electric wire can be deposited in the second section (LH2) immediately after the work in the first section (LH1) is completed without providing a waiting time. Therefore, the first slider pair (S1, S2) can be released without wasting time, and can be moved to the next work freely, and the takt time can be further shortened.

[3] An electric wire manufacturing method using an electric wire processing system (M),
the electric wire processing system (M) including
   a plurality of processing devices (1 to 10) arranged in a row in order of steps (A to E) of end processing of an electric wire, and
   a linear conveyor module (30) in which a plurality of sliders (S1 to S6) are configured to move on one guide rail (31) disposed along the plurality of processing devices (1 to 10) to convey an electric wire to be processed,
      the linear conveyor module (30) including
         a first slider pair including two sliders (S1, S2) configured to reciprocate in a first section (LH1) and hold both ends (WT1, WT2) of one electric wire, and
         a second slider pair including two sliders (S3, S4) configured to reciprocate in a second section (LH2) adjacently after the first section (LH1) and hold the both ends (WT1, WT2) of the one electric wire, and
      ranges of the first section (LH1) and the second section (LH2) are set based on a processing time of the processing device (1 to 8) in each section,
      the method including:
         holding the both ends (WT1, WT2) of the electric wire by the first slider pair, and conveying the both ends (WT1, WT2) to the processing device in the first section (LH1);
         processing the both ends (WT1, WT2) by the processing device in the first section (LH1);
         holding the processed both ends (WT1, WT2) of the electric wire by the second slider pair, and conveying the processed both ends (WT1, WT2) to
         the processing device in the second section (LH2); and processing the both ends (WT1, WT2) by the processing device in the second section (LH2).

Although various embodiments have been described above with reference to the drawings, it goes without saying that the present invention is not limited to these examples. It is apparent that those skilled in the art can produce various modifications or corrections within the scope of the claims, and it is understood that the modifications or corrections naturally fall within the technical scope of the present invention. In addition, the components described in the above embodiments may be combined freely without departing from the spirit of the invention.

The present application is based on a Japanese patent application (No. 2022-146415) filed on Sep. 14, 2022, contents of which are incorporated herein by reference.

What is claimed is:

1. An electric wire processing system comprising:
a plurality of processing devices arranged in a row in order of steps of end processing of an electric wire; and
a linear conveyor module in which a plurality of sliders are configured to move on one guide rail disposed along the plurality of processing devices to convey an electric wire to be processed, wherein
the linear conveyor module includes
a first slider pair including two sliders that move back and forth in a first section and hold both ends of one electric wire, and
a second slider pair including two sliders that move back and forth in a second section adjacently after the first section and hold the both ends of the one electric wire, and
ranges of the first section and the second section are set based on a processing time of the processing device in each section.

2. The electric wire processing system according to claim 1, further comprising:
a temporary placement chuck that temporarily places and holds, when the processing device in the second section processes only one end of the electric wire, the other end of the electric wire during processing of the one end of the electric wire in the second section.

3. An electric wire manufacturing method using an electric wire processing system,
the electric wire processing system including
a plurality of processing devices arranged in a row in order of steps of end processing of an electric wire, and
a linear conveyor module in which a plurality of sliders are configured to move on one guide rail disposed along the plurality of processing devices to convey an electric wire to be processed,
the linear conveyor module including
a first slider pair including two sliders that move back and forth in a first section and hold both ends of one electric wire, and
a second slider pair including two sliders that move back and forth in a second section adjacently after the first section and hold the both ends of the one electric wire, and
ranges of the first section and the second section are set based on a processing time of the processing device in each section,
the method comprising:
holding the both ends of the electric wire by the first slider pair, and conveying the both ends to the processing device in the first section;
processing the both ends by the processing device in the first section;
holding the processed both ends of the electric wire by the second slider pair, and conveying the processed both ends to the processing device in the second section; and
processing the both ends by the processing device in the second section.
